(19) United States
(12) Patent Application Publication
(10) Pub. No.: US 2024/0315386 A1
(43) Pub. Date: Sep. 26, 2024

(54) SHOE LIGHT SYSTME FOR SHOES AND SHOE SOLE MATCHED THEREWITH

(71) Applicant: Quanzhou Hengguang Electronics Co., Ltd., Quanzhou (CN)

(72) Inventor: YINYU HUANG, Quanzhou (CN)

(21) Appl. No.: 18/127,849

(22) Filed: Mar. 29, 2023

(30) Foreign Application Priority Data
Mar. 21, 2023 (CN) 202310278615.X

(51) Int. Cl. A43B 3/36; A43B 3/40; A43B 13/22

(52) U.S. Cl. CPC A43B 3/36; A43B 3/40; A43B 13/22

(57) ABSTRACT

The present application discloses a shoe light system for shoes and a shoe sole matched therewith comprising a plastic cavity, and a PCB board, a control chip, an induction switch, a battery, and solder joints are arranged in the plastic cavity. The control chip, induction switch, battery, and solder joints are all connected to the PCB board, the solder joints are connected with wires, and the wires are connected with shoe lights. The shoe light is an electrodeless LED light, which is creatively applied to the shoe light system, and its service life is much longer than that of ordinary shoe lights. Through the control of MCU chip, different lighting effects of shoe lights are designed by using the persistence effect of human vision, and matching soles are designed to protect the entire shoe light system in a targeted manner. It should be widely promoted and used in the market.

### CROSS-REFERENCE TO RELATED APPLICATIONS

This application claims the benefit and priority of Chinese patent application No. 202310278615.X, filed on Mar. 21, 2023, disclosure of which is hereby incorporated by reference in its entirety.

### TECHNICAL FIELD

The present application relates to a shoe light system for shoes and a shoe sole matched therewith, belonging to the field of shoes.

### BACKGROUND

Shoe lights are decorative lights made of LED lights that can be installed on shoes. Depending on the specific type, they can also be installed on clothing and bags to play a good decorative and warning effect. When the existing shoe lights are in use, the lighting method is relatively single, and it is impossible to set multiple lighting effects. The most important point is that since the shoe light is generally embedded in the sole, when the shoe light is out of power, this function will lose its effect, which is the biggest limitation of the shoe light. Therefore, a shoe light system for shoes is proposed, and according to the shoe light, a shoe sole matching the shoe light system is proposed.

### SUMMARY

Aiming at the deficiencies in the prior art, the purpose of this application is to provide a shoe light system for shoes and a shoe sole matching it, so as to solve the existing problems.

In order to achieve the above object, the application is realized through the following technical solutions: A shoe light system for shoes, comprising a plastic cavity, and a PCB board, a control chip, an induction switch, a battery, and solder joints are arranged in the plastic cavity, wherein the control chip, induction switch, battery, and solder joints are all connected to the PCB board, the solder joints are connected with wires, and the wires are connected with shoe lights. The model of the control chip is NYSA051F, the control chip has eight pins, which are respectively pins 1-8, the battery is connected to pins 1 and 8, and the induction switch is connected to pin 4, wherein ten shoe lights are provided, and the ten shoe lights are driven by pins 2, 3, 5, 6, and 7. The battery is button cell and rechargeable. In the circuit, the shoe lights are driven in a time-division and multiplexing manner by using the pins of the control chip, wherein, using the three states of high level, low level and high impedance state of the control chip, two shoe lights are connected between any two pins, and the two shoe lights are connected in parallel, and the direction of the shoe light is opposite. When you want to light up a specific shoe light, set the GPIO pins connected to its two ends to high level and low level respectively, and set the remaining GPIO pins to high impedance state. Then light up one of the shoe light beads accordingly, and then through the control of the control chip, use the human visual persistence effect to design different lighting effects of the shoe light.

The present application also provides a shoe sole based on the shoe light system, its structure comprises a shoe sole, the shoe sole is composed of a bottom layer and a top layer, the bottom layer is provided with an opening, and the opening is provided with a transparent block.

Further, the bottom layer is provided with a groove, the groove is provided with wire channels, and the bottom layer is also provided with a pad, the wire channels communicate with the opening.

Further, the bottom layer comprises a rear area, a middle area, and a front area.

Further, the top layer is provided with an elastic block and a sweat-absorbing pad, and the elastic block is located directly above the groove.

Further, a rear elastic block and a first wear-resistant strip are arranged on the rear area, and a sole groove and a middle wear-resistant block are arranged on the middle area, and flow guiding grooves are arranged on the middle wear-resistant block, and a front elastic block and a second wear strip are arranged on the front area.

Further, a stator is arranged in the groove, a rotor is arranged in the stator, and the stator matches the rotor.

Further, the stator is provided with a stator core, the rotor is provided with a permanent magnet, and the stator core is matched with the permanent magnet, a rotating rod is also provided on the rotor.

Further, a coil is provided between the stator and the rotor, and the coil is connected to the battery.

Further, a threaded mechanism and a spring are connected to the rotating rod, the spring is sheathed on the threaded mechanism, and the threaded mechanism is located below the rear elastic block. The structure of the screw mechanism and the spring is designed as a conventional press-type rotation method, so I won't go into details here.

The beneficial effect of this application is: Through the shoe light system, a variety of different shoe light effects can be designed. The present application also provides a shoe sole matching the shoe light system, the shoe light is located at the opening of the shoe sole, and the middle area of the shoe sole is provided with a middle wear-resistant block to increase the wear resistance of the shoe sole, so that the time to wear to the opening increases, thereby increasing the service life in a disguised form. In addition, flow guiding grooves are also provided for guiding the water outward. The entire shoe light system is set in the groove, and is equipped with a stator and a rotor for charging. The rear area of the bottom is also equipped with a rear elastic block to cooperate with the first wear strip. The overall design of the application is reasonable. The shoe light system adds a variety of lighting methods for the shoe light, and is equipped with a shoe sole that matches the shoe light system, which can not only protect the entire shoe light system in a targeted manner, but also charge the shoe light system. This effectively solves the problem of failure caused by insufficient battery power in shoe light systems in the art.

### BRIEF DESCRIPTION OF DRAWINGS

Other characteristics, objects and advantages of the present application will become more apparent by reading the detailed description of non-limiting embodiments with reference to the following drawings:

FIG. 1 is a schematic structural diagram of the shoe light system of a shoe light system for shoes and shoe sole matched therewith according to the present application;

FIG. 2 is a schematic structural diagram of the battery of a shoe light system for shoes and shoe sole matched therewith according to the present application;

FIG. 3 is a schematic structural diagram of the shoe sole of a shoe light system for shoes and shoe sole matched therewith according to the present application;

FIG. 4 is a schematic structural diagram of the bottom layer of a shoe light system for shoes and shoe sole matched therewith according to the present application;

FIG. 5 is a schematic structural diagram of the bottom of the bottom layer of a shoe light system for shoes and shoe sole matched therewith according to the present application;

FIG. 6 is a schematic structural diagram of the top layer of a shoe light system for shoes and shoe sole matched therewith according to the present application;

FIG. 7 is a schematic structural diagram of the stator of a shoe light system for shoes and shoe sole matched therewith according to the present application;

FIG. 8 is a schematic structural diagram of the rotor of a shoe light system for shoes and shoe sole matched therewith according to the present application;

FIG. 9 is a schematic structural diagram of the rotor of a shoe light system for shoes and shoe sole matched therewith according to the present application, wherein the rotor is working;

FIG. 10 is a schematic structural diagram of the circuit of a shoe light system for shoes and shoe sole matched therewith according to the present application;

FIG. 11 is a schematic structural diagram of the working principle of the shoe light of a shoe light system for shoes and shoe sole matched therewith according to the present application.

Reference signs: Plastic cavity 1, PCB board 101, Control chip 102, Induction switch 103, Battery 104, Solder joint 105, Wire 106, Shoe light 107, Sole 2, Bottom layer 3, Top layer 4, Opening 5, Transparent block 501, Groove 301, Wire channel 302, Pad 303, Rear area 304, Middle area 305, Front area 306, Elastic block 401, Sweat-absorbing pad 402, Rear elastic block 3041, First wear strip 3042, Sole groove 3051, Middle wear-resistant block 3052, Flow guiding groove 3053, Front elastic block 3061, Second wear strip 3062, Stator 307, Stator core 3071, Rotor 308, Permanent magnet 3081, Rotating rod 3082, Coil 309, Screw mechanism 310, Spring 311.

### DETAILED DESCRIPTION

In order to make the technical means, creative features, goals and effects achieved by this application easy to understand, the following will further elaborate this application in conjunction with specific implementation methods.

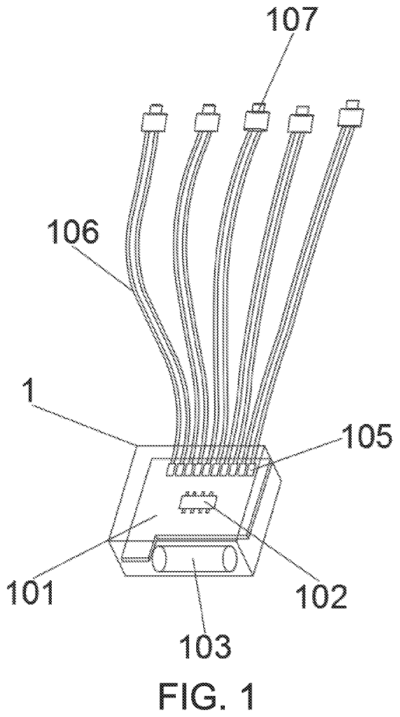

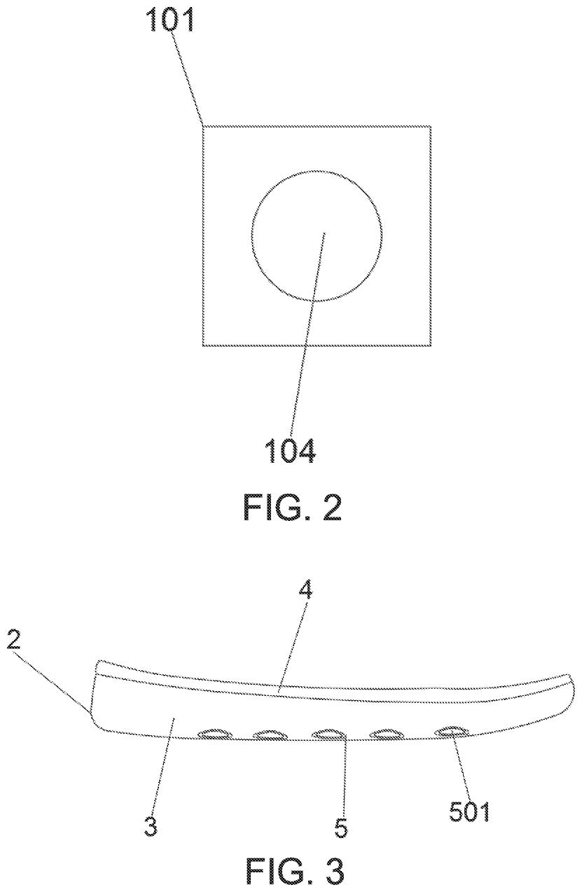

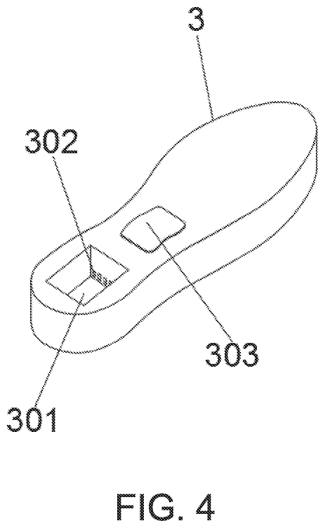

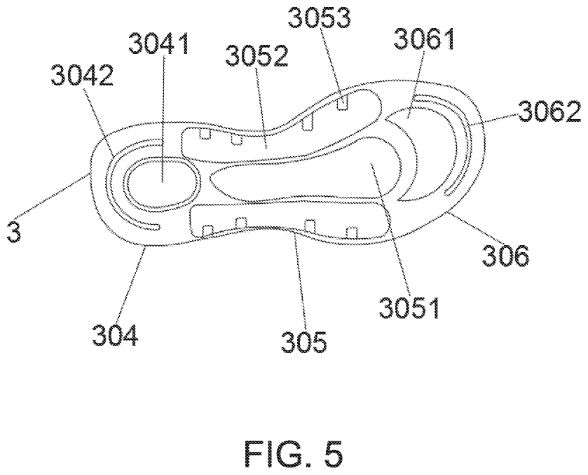

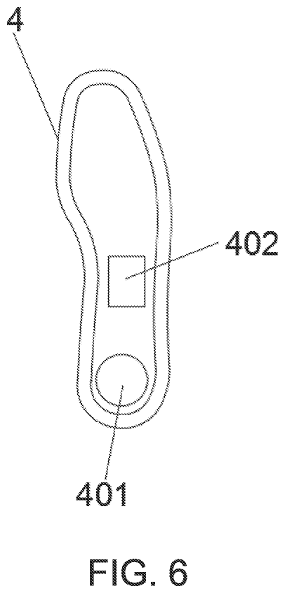

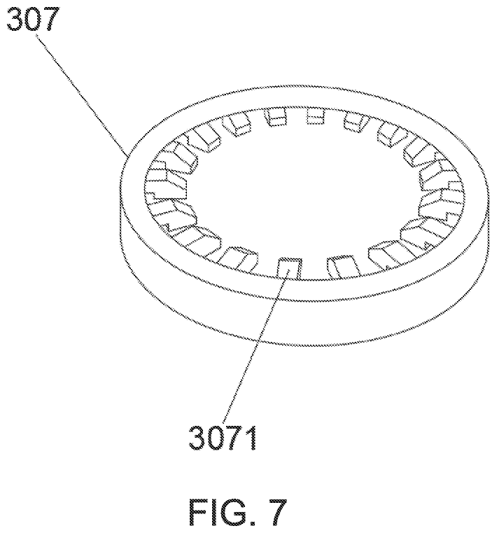

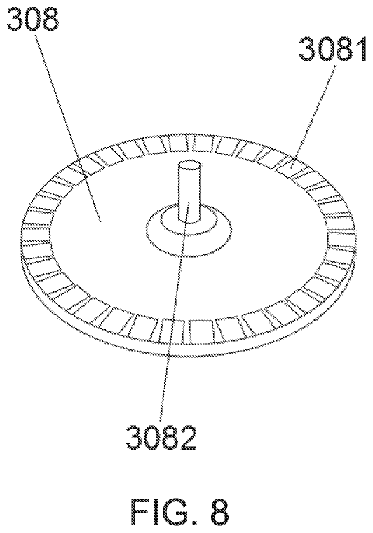

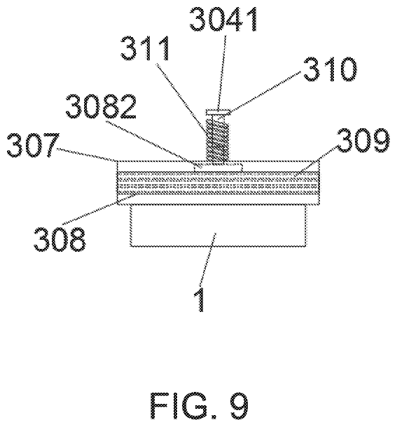

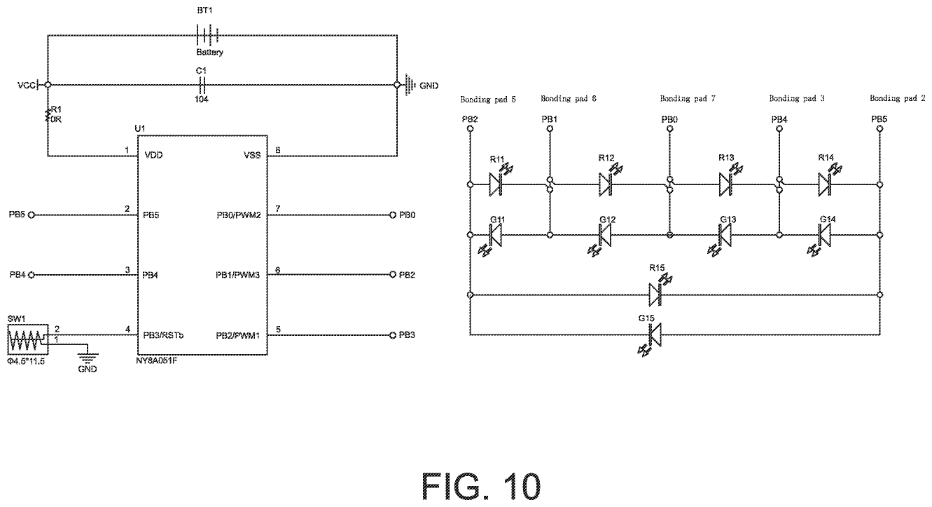

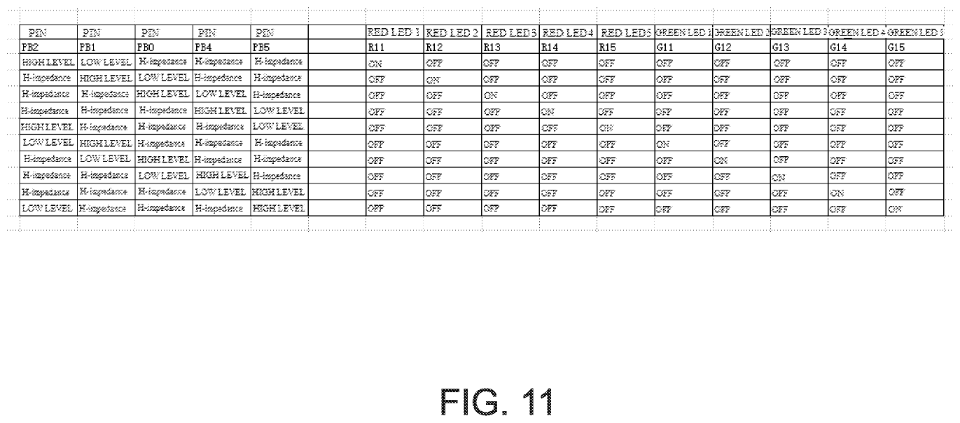

Please refer to FIG. 1-FIG. 11, this application provides a technical solution for a shoe light system for shoes, comprising a plastic cavity 1, and a PCB board 101, a control chip 102, an induction switch 103, a battery 104, and solder joints 105 are arranged in the plastic cavity 1, wherein the control chip 102, induction switch 103, battery 104, and solder joints 105 are all connected to the PCB board 101, the solder joints 105 are connected with wires 106, and the wires 106 are connected with shoe lights 107. The model of the control chip 102 is NY8A051F, the control chip 102 has eight pins, which are respectively pins 1-8, the battery 104 is connected to pins 1 and 8, and the induction switch 103 is connected to pin 4, wherein ten shoe lights 107 are provided, and the ten shoe lights 107 are driven by pins 2, 3, 5, 6, and 7. As shown in FIG. 11, using the three states of high level, low level and high impedance state of the control chip 102, two shoe lights 107 are connected between any two pins, and the two shoe lights are connected in parallel, and the direction of the shoe light is opposite. When you want to light up a specific shoe light, set the GPIO pins connected to its two ends to high level and low level respectively, and set the remaining GPIO pins to high impedance state. Then light up one of the shoe light beads accordingly, and then through the control of the control chip, use the human visual persistence effect to design different lighting effects of the shoe light.

The present application also provides a shoe sole based on the shoe light system, its structure comprises a shoe sole 2, the shoe sole 2 is composed of a bottom layer 3 and a top layer 4, the bottom layer 3 is provided with an opening 5, and the opening 5 is provided with a transparent block 501. The bottom layer 3 is provided with a groove 301, the groove 301 is provided with wire channels 302, and the bottom layer 3 is also provided with a pad 303, the wire channels 302 communicate with the opening 5. The bottom layer 3 comprises a rear area 304, a middle area 305, and a front area 306, and the top layer 4 is provided with an elastic block 401 and a sweat-absorbing pad 402, and the elastic block 401 is located directly above the groove 301. A rear elastic block 3041 and a first wear-resistant strip 3042 are arranged on the rear area 304, and sole grooves 3051 and a middle wear-resistant block 3052 are arranged on the middle area 305, and flow guiding grooves 3053 are arranged on the middle wear-resistant block 3052, and a front elastic block 3061 and a second wear strip 3062 are arranged on the front area 306. A stator 307 is arranged in the groove 301, a rotor 308 is arranged in the stator 307, and the stator matches the rotor. The stator 307 is provided with a stator core 3071, the rotor 308 is provided with a permanent magnet 3081, and the stator core 3071 is matched with the permanent magnet 3081, a rotating rod 3082 is also provided on the rotor 308. A coil 309 is provided between the stator 307 and the rotor 308, and the coil 309 is connected to the battery 104. A threaded mechanism 310 and a spring 311 are connected to the rotating rod 3082, the spring 311 is sheathed on the threaded mechanism 310, and the threaded mechanism 310 is located below the rear elastic block 3041.

For example, during use, stepping down while walking will cause the induction switch 103 to be triggered, so that the control chip 102 can control the shoe light 107 according to the set program, wherein the shoe light 107 is located in the opening 5 and passes through the transparent block. 501 to let the light out. There is also a matching sole that can be used to charge the shoe light system. Through the action of stepping down when walking, the heel will step on the elastic block 401, so that the elastic block 401 presses down the pressing rotation structure formed by the screw mechanism 310 and the spring 311, so that the rotor 308 rotates. The stator core 3071 on the stator 307 cuts the permanent magnet 3081 continuously, so that the battery 104 can be charged through the coil 309. Through actions when walking, not only can the shoe light 107 be lit on, but also the battery 104 can be charged at the same time.

The basic principles and main features of the present application and the advantages of the present application have been shown and described above. It will be apparent to those skilled in the art that the present application is not limited to the details of the exemplary embodiments described above, but that the present application can be implemented in other specific forms without departing from the spirit or essential characteristics of the present application. Therefore, the embodiments should be regarded as exemplary rather than restrictive in every respect. The scope of the application is defined by the appended claims rather than the above description, and all changes that come within the meaning and range of equivalency of the claims are intended to be embraced therein. Any reference sign in a claim should not be construed as limiting the claim concerned.

In addition, it should be understood that although this specification describes embodiments, not every embodiment only includes an independent technical solution, and this description in the specification is only for clarity. Those skilled in the art should take the description as a whole, and the technical solutions in each embodiment can also be properly combined to form other implementation modes that can be understood by those skilled in the art.

What is claimed is:

1. A shoe light system for shoes, comprising a plastic cavity (1), and a PCB board (101), a control chip (102), an induction switch (103), a battery (104), and solder joints (105) are arranged in the plastic cavity (1), wherein the control chip (102), induction switch (103), battery (104), and solder joints (105) are all connected to the PCB board (101), the solder joints (105) are connected with wires (106), and the wires (106) are connected with shoe lights (107), the shoe light is configured to be an electrodeless LED light.

2. The shoe light system for shoes according to claim 1, wherein the model of the control chip (102) is NY8A051F, and the control chip (102) has eight pins, which are respectively pins 1-8, the battery (104) is connected to pins 1 and 8, and the induction switch (103) is connected to pin 4, wherein ten shoe lights (107) are provided, and the ten shoe lights (107) are driven by pins 2, 3, 5, 6, and 7, and the shoe lights (107) are driven in a time-division and multiplexing manner by using the pins of the control chip (102), wherein, using the three states of high level, low level and high impedance state of the control chip (102), two shoe lights (107) are connected between any two pins, and the two shoe lights (107) are connected in parallel, and the direction of the shoe light (107) is opposite, when a specific shoe light (107) is to be lit, the GPIO pins connected to both ends are set to high level and low level respectively, and the remaining GPIO pins are set to high impedance state, then a light bead of one of the shoe lights (107) will be lit accordingly.

3. A shoe sole based on the shoe light system according to claim 1, characterized in that its structure comprises a shoe sole (2), the shoe sole (2) is composed of a bottom layer (3) and a top layer (4), the bottom layer (3) is provided with an opening (5), and the opening (5) is provided with a transparent block (501).

4. The shoe sole according to claim 3, wherein the bottom layer (3) is provided with a groove (301), the groove (301) is provided with wire channels (302), and the bottom layer (3) is also provided with a pad (303), the wire channels (302) communicate with the opening (5).

5. The shoe sole according to claim 4, wherein the bottom layer (3) comprises a rear area (304), a middle area (305), and a front area (306).

6. The shoe sole according to claim 5, wherein the top layer (4) is provided with an elastic block (401) and a sweat-absorbing pad (402), and the elastic block (401) is located directly above the groove (301).

7. The shoe sole according to claim 6, wherein a rear elastic block (3041) and a first wear-resistant strip (3042) are arranged on the rear area (304), and sole grooves (3051) and a middle wear-resistant block (3052) are arranged on the middle area (305), and flow guiding grooves (3053) are arranged on the middle wear-resistant block (3052), and a front elastic block (3061) and a second wear strip (3062) are arranged on the front area (306).

8. The shoe sole according to claim 7, wherein a stator (307) is arranged in the groove (301), a rotor (308) is arranged in the stator (307), and the stator (307) matches the rotor (308).

9. The shoe sole according to claim 8, wherein the stator (307) is provided with a stator core (3071), the rotor (308) is provided with a permanent magnet (3081), and the stator core (3071) is matched with the permanent magnet (3081), a rotating rod (3082) is also provided on the rotor (308), a coil (309) is provided between the stator (307) and the rotor (308), and the coil (309) is connected to the battery (104).

10. The shoe sole according to claim 9, wherein a threaded mechanism (310) and a spring (311) are connected to the rotating rod (3082), the spring (311) is sheathed on the threaded mechanism (310), and the threaded mechanism (310) is located below the rear elastic block (3041).
